(19) United States
(12) Patent Application Publication
(10) Pub. No.: US 2008/0154390 A1
(43) Pub. Date: Jun. 26, 2008

(54) Predicting reactant production in a fuel cell system

(76) Inventors: Zhi Zhou, Selkirk, NY (US); Jing Ou, Latham, NY (US); Donald F. Rohr, Rexford, NY (US); Vishnu Poonamallee, Tamilnadu (IN)

Correspondence Address: TROP PRUNER & HU, PC, 1616 S. VOSS ROAD, SUITE 750, HOUSTON, TX, 77057-2631, US

(21) Appl. No.: 11/645,134

(22) Filed: Dec. 22, 2006

(51) Int. Cl. G05B 13/04; G06F 7/62; H01M 8/04

(52) U.S. Cl. 700/30; 429/22; 703/13

(57) ABSTRACT

A technique includes providing a mathematical model of reactant production by a reactant processor of a fuel cell system. The technique also includes during a time period in which the fuel cell system is continuously operating, adapting the model based on feedback received from the fuel cell system and controlling the fuel cell system using an indication of the reactant production from the model.

### BACKGROUND

The invention generally relates to predicting reactant production in a fuel cell system, and more particularly, the invention relates to predicting hydrogen production in a fuel cell system.

A fuel cell is an electrochemical device that converts chemical energy directly into electrical energy. There are many different types of fuel cells, such as solid oxide, molten carbonate, phosphoric acid, methanol and proton exchange membrane (PEM) fuel cells.

As a more specific example, a PEM fuel cell includes a PEM membrane, which permits only protons to pass between an anode and a cathode of the fuel cell. A typical PEM fuel cell may employ polysulfonic-acid-based ionomers and operate up to 80° Celsius (C.). Another type of PEM fuel cell may employ a phosphoric-acid-based polybenziamidazole (PBI) membrane that operates in the 150° to 200° temperature range.

At the anode of the PEM fuel cell, diatomic hydrogen (a fuel) ionizes to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:

H₂→2H⁺+2e⁻ at the anode of the cell, and Equation 1

O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Catalyzed electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

### SUMMARY

In an embodiment of the invention, a technique includes providing a mathematical model of reactant production by a reactant processor of a fuel cell system. The technique also includes during a time period in which the fuel cell system is continuously operating, adapting the model based on feedback received from the fuel cell system and controlling the fuel cell system using an indication of the reactant production from the model.

In another embodiment of the invention, a fuel cell system includes a reactant processor and a controller. The reactant processor provides a reactant flow for a fuel cell of the fuel cell system. The controller uses a mathematical model to generate an indication of reactant production by the reactant processor. The controller also, during a time period in which the fuel cell system is continuously operating, adapts the model based on feedback that is received from the fuel cell system and controls the fuel cell system using an indication of the reactant production from the model.

In yet another embodiment of the invention, an article includes a computer readable storage medium that is accessible by a processor-based system to store instructions that when executed by the processor-based system cause the processor-based system to provide a mathematical model of reactant production by a reactant processor of a fuel cell system. The instructions when executed also cause the processor-based system to during a time period in which the fuel cell system is continuously operating, adapt the model based on feedback that is received from the fuel cell system and control the fuel cell system using an indication of the reactant production from the model.

Advantages and other features of the invention will become apparent from the following drawing, description and claims.

### BRIEF DESCRIPTION OF THE DRAWING

FIG. 1 is a schematic diagram of a fuel cell system according to an embodiment of the invention.

FIGS. 2 and 3 are flow diagrams of techniques to use a mathematical model to predict reactant production according to embodiments of the invention.

FIG. 4 is a schematic diagram of a control and software architecture used by the fuel cell system of FIG. 1 to control oxidant flows.

FIG. 5 is a chart illustrating two different models to predict hydrogen production in the fuel cell system.

FIG. 6 is a chart illustrating control of a cathode air blower of the fuel cell system of FIG. 1 using a model that predicts hydrogen production according to an embodiment of the invention.

### DETAILED DESCRIPTION

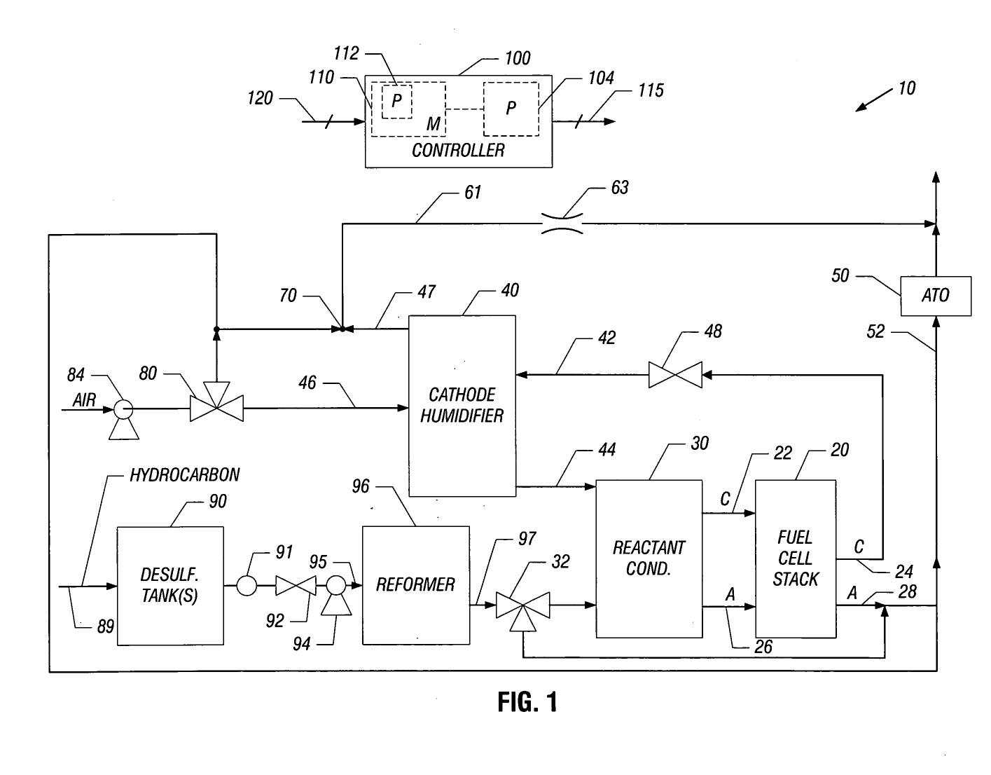

Referring to FIG. 1, an embodiment 10 of a fuel cell system in accordance with the invention includes a fuel cell stack 20, which produces electricity for an external load (not shown) to the fuel cell system 10 in response to fuel and oxidant flows through the stack 20. In this regard, the fuel cell stack 20 includes a cathode inlet 22, which receives an incoming oxidant flow (an air flow, for example) that is communicated through the cathode chamber of the fuel cell stack 20 to produce a corresponding cathode exhaust flow at a cathode outlet 24. The fuel cell stack 20 also receives an incoming fuel flow (a reformate flow containing diatomic hydrogen, for example) at an anode inlet 26. The fuel flow is communicated through the anode chamber of the fuel cell stack 20 to produce a corresponding anode exhaust at an anode outlet 28 of the stack 20.

For purposes of producing the incoming fuel flow to the fuel cell stack 20, the fuel cell system 10 includes a reformer 96. As an example, the reformer 96 may collectively represent an autothermal reformer (ATR), a low temperature (water gas) shift (LTS) reactor and a preferential oxidation (PROX) reactor. Regardless of its particular form, however, the reformer 96 converts an incoming hydrocarbon flow (a natural gas or liquefied petroleum gas (LPG) flow, as examples) into a corresponding reformate flow at its outlet 97. The reformate flow is not pure hydrogen, but rather represents a certain percentage of hydrogen, which provides fuel to sustain electrochemical reactions inside the fuel cell stack 20.

A controller 100 of the fuel cell system 10 bases control of various components of the system 10 on the level of hydrogen production by the reformer 96. One way to determine the level of hydrogen production is to place a sensor in the reformate flow. However, direct sensing using a hydrogen sensor may be quite technologically challenging and/or may be relatively expensive.

More specifically, the hydrogen production of the reformer 96 typically is a key parameter that is used to control various aspects of the fuel cell system 10, such as the flow produced by a fuel air blower 94, the flow produced by a cathode air blower 84 and the position of a three-way oxidant control valve 80 (as a non-exhaustive list). Due to the above-mentioned difficulty in using a hydrogen sensor to directly sense the output flow from the reformer 96, the controller 100, in accordance with embodiments of the invention described herein, models the hydrogen production of the reformer 96; and based on this model, the controller 100 estimates, or predicts, the reformer's hydrogen production.

As described further below, in accordance with some embodiments of the invention, the model that is used by the controller 100 may be either a non-linear or a linear model of the production as a function of the incoming fuel flow to the reformer 96 for a given or fixed reformer. It is noted that the hydrogen production of the reformer 96 may be a combination of the fuel flow, the outlet temperature of the reformer 96, fuel composition, and parameters associated with the ATR, LTS and PROX reactors, such as the oxygen-to-carbon ratio, operating pressure and steam-to-carbon ratio. However, for a fixed or well controlled reactor outlet temperature and a fixed operating pressure, the hydrogen production may be estimated based solely on the incoming fuel flow to the reformer 96. Although, a model that is a function of the incoming fuel flow is described herein for purposes of example, it is understood that in other embodiments of the invention, one or more of the above-mentioned parameters may be incorporated into the model; and thus, the model may be a function of more than the incoming fuel flow rate to the reformer 96.

If the model of hydrogen production that is used by the controller 100 is static and does not account for such factors as the aging of the reformer 96, undesirable conditions (methane slip, carbon monoxide leaving the reformer 96, etc.) may occur as the actual operating conditions of the system 10, which causes the prediction of hydrogen production to be relatively inaccurate. Therefore, in accordance with embodiments of the invention described herein, the controller 100 adapts the model based on feedback that is received from the fuel cell system 10.

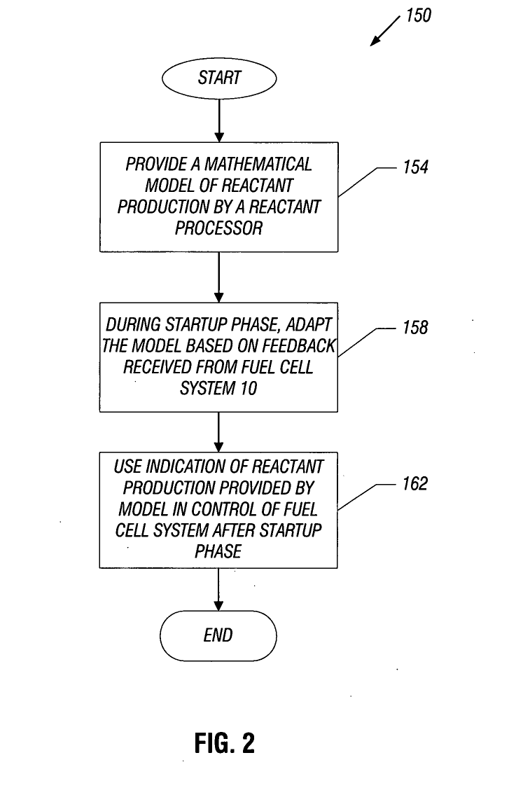

Referring also to FIG. 2, more specifically, in accordance with some embodiments of the invention, the controller 100 performs a technique 150. Pursuant to the technique 150, the controller 100 provides a mathematical model of reactant production by a reactant processor, pursuant to block 154. In the example described herein, the reactant processor is the reformer 96, and the reactant production is the hydrogen production by the reformer 96. During a startup phase of the fuel cell system 10, the controller 100 adapts (block 158) the model based on feedback that is received from the system 10.

In the context of this application, the “startup phase” means the period in which the fuel cell system 10 is first powering up. This phase thus, generally is the time period when components of the fuel cell system 10 are starting, or powering up, but power is not being yet provided by the fuel cell system to an external load. During the startup phase, the fuel cell system 10 may perform such actions as purging the fuel cell stack 20, gradually increasing power production from the fuel cell stack 20, warming up an ATO 50, warming up the reformer 96, performing power on tests to check system components, etc. After the expiration of the startup phase, the fuel cell system 10 enters the normal power production phase.

Still referring to the technique 150 (FIG. 2), after the model has been adapted during the startup phase, the controller 100 uses (block 162) an indication of reactant production that is provided by the model in the control of the fuel cell system, pursuant to block 162.

It is noted that in other embodiments of the invention, the controller 100 may adapt the model based on feedback that is received during other phases, or modes of operation, of the fuel cell system 10, other than the startup phase. As examples, depending on the particular embodiment of the invention, the controller 100 may adapt the model based on feedback received during at least one of the startup, normal and shutdown phases of the fuel cell system 10. Thus, many variations are contemplated and are within the scope of the appended claims.

Referring back to FIG. 1, in accordance with some embodiments of the invention, the reformer 96 receives a combined air and fuel flow from a fuel air blower 94. An incoming fuel flow, such as LPG or natural gas, is received at a suction inlet of the blower 94 and combined with air to provide a feedstock flow to the reformer 96. The incoming fuel flow originates with a hydrocarbon flow that is received at an inlet 89 of a set of one or more desulfurization tanks 90. The desulfurization tank(s) 90 include beds to remove various sulfur compounds from the incoming hydrocarbon flow. The filtered hydrocarbon flow may then pass through a variable flow path valve 92 (a solenoid valve, for example) and then to the suction inlet of the fuel air blower 94. The fuel cell system 10 may also include a flow meter 91 that is connected to the outlet of the desulfurization tank(s) 90 for purposes of determining the rate of fuel flow to the reformer 96. In accordance with some embodiments of the invention, the controller 100 may control the incoming fuel flow to the reformer 96 by regulating operation of the valve 92.

The reformate flow that is provided by the reformer 96 may be communicated through a three-way valve 32. The three-way valve 32 includes one outlet that provides a bypass flow (which bypasses a reactant conditioner 30 and the fuel cell stack 20) to the anode exhaust. The bypass may be activated, for example, during the startup phase of the fuel cell system 10. During normal operation, the controller 100 operates the three-way valve 32 so that the valve 32 provides a reformate flow to a reactant conditioner 30. After passing through the reactant conditioner 30, the reformate flow enters the anode inlet 26 of the fuel cell stack 20.

In accordance with some embodiments of the invention, the air blower 84 is shared by both the fuel cell stack 20 and an anode tailgas oxidizer (ATO) 50. In this regard, in accordance with some embodiments of the invention, the air blower 84 produces an oxidant flow that is received by a three-way valve 80. The controller 100 controls operation of the three-way valve 80 for purposes of dividing the incoming oxidant flow between the ATO 50 and the fuel cell stack 20. For the oxidant flow that is routed to the fuel cell stack 20, an inlet 46 of a cathode humidifier 40 is connected to an outlet of the three-way valve 80 for purposes of receiving the oxidant flow. Inside the cathode humidifier 40, moisture from a returning cathode exhaust from the fuel cell stack 20 is communicated to the incoming oxidant flow for purposes of humidifying the flow. The resultant humidified flow appears at an outlet 44 of the cathode humidifier 40 and passes through a reactant conditioner 30. From the reactant conditioner 30, the oxidant flow enters the cathode inlet 22 of the fuel cell stack 20. As depicted in FIG. 1, the cathode exhaust outlet 24 of the fuel cell stack 20 may be coupled back to an inlet of the cathode humidifier 40. As shown, a valve 48 (a solenoid valve, for example) may be coupled between the cathode exhaust outlet 24 and the inlet 42 of the cathode humidifier 40.

Another outlet of the three-way valve 80 is connected to provide a flow to an inlet 52 of the ATO 50. As shown in FIG. 1, at inlet 52, the oxidant flow may be combined with the anode exhaust of the fuel cell stack 20 for purposes of producing a feedstock flow for oxidation inside the ATO 50. The fuel cell system 10 may also include a bypass flow path 61, a path that may be used for purposes of routing excess air flow to the exhaust of the ATO 50. The bypass line 61 may include an orifice valve 63 which may have a fixed flow path or may have a variable flow path (controlled by the controller 100), depending on the particular embodiment of the invention. As shown in FIG. 1, the bypass line 61 may be connected at a junction 70 to the outlet 47 of the cathode humidifier 40 and to the outlet of the three-way valve 80 that provides the flow to the ATO 50.

The controller 100, in accordance with some embodiments of the invention, includes a processor 104, which may be one or more microprocessors or microcontrollers, depending on the particular embodiment of the invention. Furthermore, the microcontroller(s)/microprocessor(s) may be located on separate platforms, may be located on the same semiconductor die, may be located in the same semiconductor package or may be located on separate dies or packages, depending on the particular embodiment of the invention. Regardless of its particular form, the processor 104 is coupled to a memory 110. The memory 110 may be internal or external to the controller 100, may be provided by several semiconductor devices or platforms or may be integrated into a single semiconductor die, depending on the particular embodiment of the invention.

In general, the memory 110 stores program instructions 112, which when executed by the processor 104, cause the controller 100 to perform one or more of the techniques that are disclosed herein. In particular, in accordance with some embodiments of the invention, via the execution of the program instructions 112, the processor 104 creates a model, which models the hydrogen production of the reformer 96 as a function of the incoming fuel flow to the reformer 96. Additionally, the program instructions 112, when executed by the processor 104, cause the controller 100 to adapt the model based on feedback from the fuel cell system 10 that is received by the controller 100.

In accordance with some embodiments of the invention, the controller 100 includes various output communication lines 115 for purposes of controlling the various components of the fuel cell system 10, such as the air blower 84, the three-way valve 80, the reformer 96, the fuel blower 94, the valve 92, the three-way valve 32, the power conditioning circuitry (not depicted in FIG. 1), etc. The controller 100 may also include various input communication lines 120 for purposes of receiving communications from other controllers, signals from various sensors and cell voltage monitoring circuitry (not depicted in FIG. 1), measured voltages and currents, etc.

In accordance with embodiments of the invention described herein, the predicted hydrogen production (for the model) is used for purposes of controlling the cathode air blower 84. It is noted that in other embodiments of the invention, the predicted hydrogen production may be used for purposes of controlling other components of the fuel cell system 10. Thus, the specific example that is set forth herein is merely for purposes of clarifying the following discussion, as other embodiments are possible and are within the scope of the appended claims.

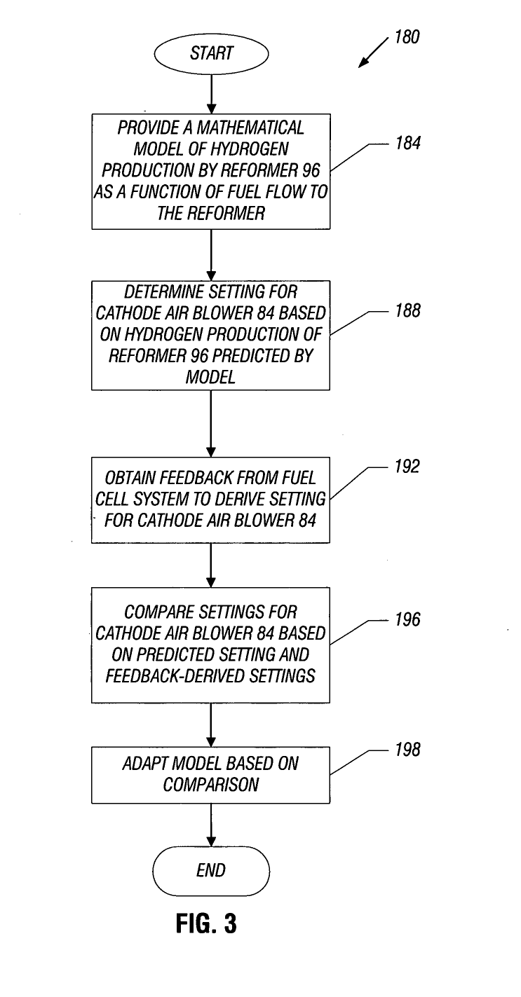

Referring to FIG. 4, in accordance with some embodiments of the invention, the controller 100 uses a control and software architecture 200 for purposes of controlling the oxidant flows to the fuel cell stack 20 and the ATO 50 (see FIG. 1). As described further below, in this control, the controller 100 uses the predicted hydrogen production of the reformer 96, which is provided by the model.

In general, the control and software architecture 200 includes two control loops: a slow loop 210 and a fast loop 250. The slow loop 210 is used for purposes of controlling the three-way valve 80 to determine the division of the oxidant stream (provided by the cathode air blower 84) between the fuel cell stack 20 and the ATO 50. To perform this control, the controller 100 executes a optimization routine 212, which is further described in U.S. patent application Ser. No. ______, entitled, “CONTROLLING OXIDANT FLOWS IN A FUEL CELL SYSTEM,” which has a common assignee, is concurrently filed herewith and is hereby incorporated by reference. The slow loop 210 may also include a feedforward routine 216, which is optional and may be used for purposes of feedforward compensation for the control of the air blower 84.

The controller 100 uses the fast loop 250 for purposes of controlling the speed of the air blower 84. As shown, the controller 100 takes into account different parameters when controlling the air blower speed. A routine 220 takes into account the temperature of the ATO 50 and the difference between this temperature and a predetermined threshold ATO temperature. A routine 242 takes into account the oxygen content of the ATO exhaust flow, as further described in U.S. patent application Ser. No. ______, entitled, “DETECTING AND CONTROLLING A FUEL-RICH CONDITION OF A REACTOR IN A FUEL CELL SYSTEM,” which has a common assignee, is concurrently filed herewith and is hereby incorporated by reference.

The fast loop 250 also includes a feedforward routine 240 which indicates a speed for the air blower 84 based on a predicted hydrogen flow from the anode exhaust of the fuel cell stack 20 to the ATO 50. This predicted parameter, (called “H₂Flow2ATO”) is derived based on the predicted hydrogen production by the reformer 96.

The results of the routines 220, 240 and 242 are combined (as indicated by an adder 246) to produce a control signal to regulate the speed of the blower 84.

Thus, based on the model's prediction of the hydrogen production of the reformer 96, the controller 100 derives a setting for the air blower 84, i.e., a setting for the blower's speed. As described further below, the controller 100 may use another indication of the air blower's speed, which is provided by feedback, for purposes of evaluating and adapting the model based on actual operating conditions, reformer age, etc. More specifically, in accordance with some embodiments of the invention, the controller 100 uses results that are provided by the feedback control routine 220 for purposes of evaluating and adapting the model. In this regard, based on the ATO temperature, the result provided by execution of the routine 220 indicates a particular speed for the blower 84. The controller 100 compares this indicated speed with the indicated (summation) speed that is derived by execution of the feedforward control routines 240, 242, and 216. By comparing these two results, the controller 100 adapts the model of hydrogen production accordingly.

Thus, in accordance with some embodiments of the invention, the controller 100 may, via the execution of the program instructions 112 (see FIG. 1), perform a technique 180 that is depicted in FIG. 3. Pursuant to the technique 180, a mathematical model of hydrogen production by the reformer 96 is provided as a function of a fuel flow to the reformer 96, pursuant to block 184. Based on the hydrogen production predicted by the model, the controller determines (block 188) a setting for the cathode air blower 84. The controller 100 then obtains (block 192) feedback from the fuel cell system 10 to derive a setting for the cathode air blower 84. Thus, this feedback may be provided by the feedforward routines 240, 242, and 216 (see FIG. 4), in accordance with some embodiments of the invention.

The controller 100, pursuant to the technique 180, compares (block 196) the settings for the cathode air blower 84 based on the predicted and feedback-derived settings. The controller 100 then adapts the model for hydrogen production based on the comparison, as depicted in block 198.

As an example, the feedback control routine 220 may indicate an air blower speed of “50,” and the feedforward control routines 240, 242, and 216 may indicate an air blower speed of “45,” an error of 5 percent. The controller 100 may then adapt the model to match or bring the two speed indications closer together.

It is noted that the technique 180 may be performed in the startup phase of the fuel cell system 10, as previously discussed above. As an example of one particular model for hydrogen production in accordance with an embodiment of the invention, the model may be based on the following linear equation:

H₂Flow=a·fuelFlow+b, Eq. 1

where “a” and “b” represent constants that are adjusted based on curve fitting (regression model) for purposes of modeling the hydrogen production as a linear function of the incoming fuel flow to the reformer 96. In a particular fuel cell system in which the model was tested and further described below, a and b were determined to be 7.5865 and 0.9044, respectively for a standard liters per minute (slm) representation. It is noted that these values are for purposes of example only for the specific fuel cell system. Thus, these parameters will vary depending on the particular fuel cell system. All such variations are contemplated and are within the scope of the appended claims.

Thus, one way to derive the model is through the use of curve fitting (i.e., a regression model). The model may be derived in other ways. For example, a carbon mass balance may be used for purposes of deriving the model in accordance with other embodiments of the invention. More specifically, based on the assumption of no or negligible methane slip and no or negligible carbon monoxide through the reformer 96, all of the carbon content in the incoming fuel is fully converted into the form of carbon dioxide. That is, the carbon component is balanced on two ends of the reformer 96, as described below:

Fuel Flow CarbCountInFuel=Reformate Flow·MoleFraction_CO2, Eq. 2

wherein “Fuel Flow” represents the incoming fuel flow to the reformer 96, “CarbCountInFuel” represents the number of carbon atoms in the hydrocarbon composition of the incoming fuel flow, “Reformate Flow” represents the outgoing flow from the reformer 96, and “MoleFraction_CO2” represents the molar fraction of carbon dioxide.

The hydrogen production is a function of the reformate flow, and the mole fraction of hydrogen in reformate flow, as described below:

Hydrogen Flow=Reformate Flow·MoleFraction_H₂, Eq. 3

where “Hydrogen Flow” represents the hydrogen production by the reformer 96, and “MoleFraction_H₂” represents the molar fraction of the reformate flow due to hydrogen.

Based on the relationships set forth above in Eqs. 2 and 3, the hydrogen flow, or production, may be represented as follows:

Hydrogen Flow=Fuel Flow·CarbonCountInFuel·MoleFraction_H₂/MoleFraction_CO2, Eq. 4

Based on the specific system used to derive the parameters a and b discussed above, for the same system, it was determined experimentally that the parameters in Eq. 4 are as follows:
CarbCountInFuel=2.98
MoleFraction_CO2—19.8%
MoleFraction_H₂=48.5%

These specific numbers, the hydrogen production by the reformer 96 (in slm) was determined to be as follows:

Hydrogen Flow=7.3·Fuel Flow, Eq. 5

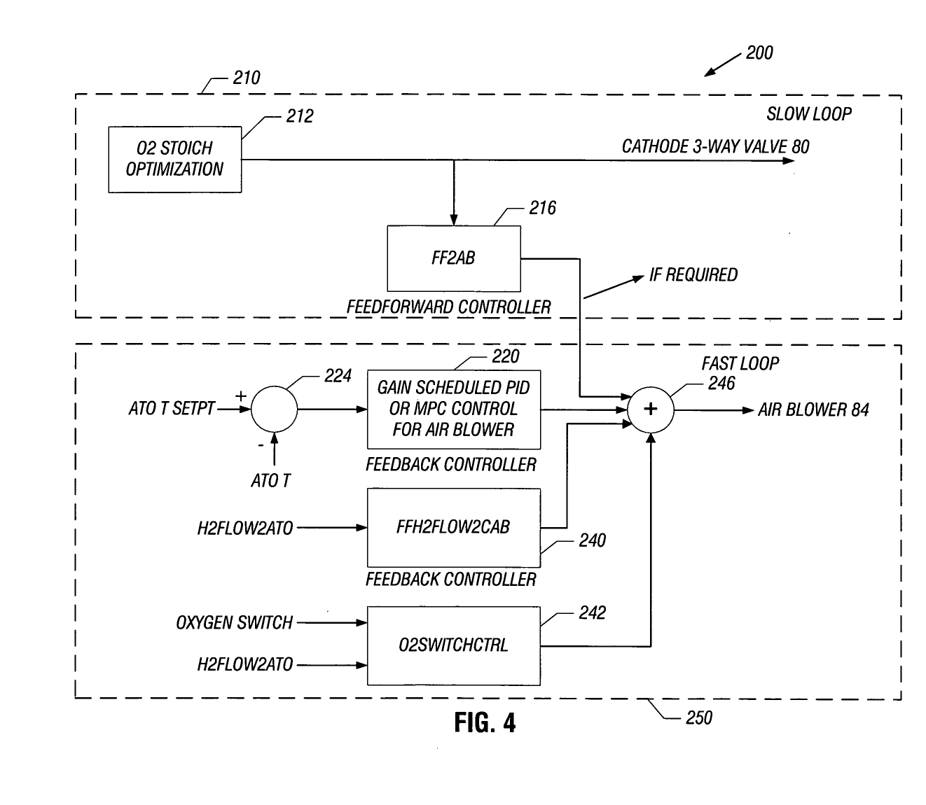

FIG. 5 is a chart 300, which illustrates the above-described linear and carbon mass-derived models. More specifically, reference numerals 320 and 324 represent the carbon mass-derived and linear models, respectively. FIG. 5 also depicts a discrepancy percentage 330 between the two models and a relative discrepancy 328. As can be seen, on a relative scale, the discrepancy between the two models decreases as fuel flow (as represented along an axis 310) and thus, power level increases.

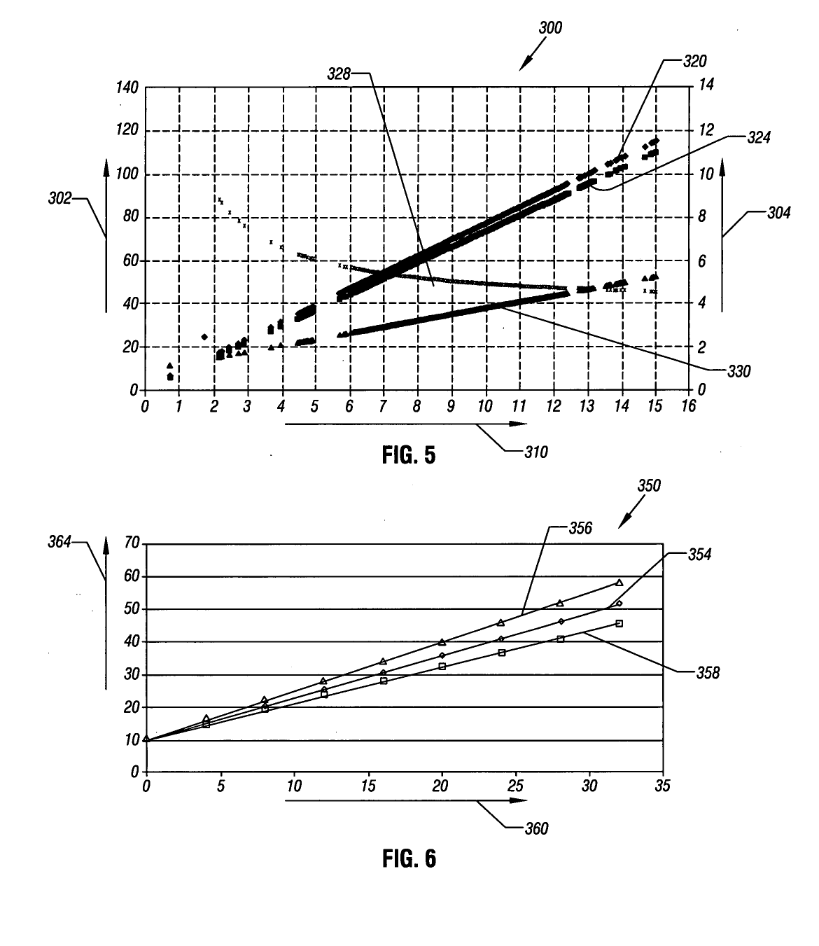

Referring to FIG. 6, error in the model causes corresponding imprecise control of the cathode air blower 84. FIG. 6 represents a line 354 (representing the linear model) for a motor setting for the cathode air blower (along a vertical axis 364) versus a percentage of hydrogen production (represented along a horizontal axis 360). The variation for 15 percent (see line 356) and negative 15 percent (see line 358) is also depicted in FIG. 6.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
providing a mathematical model of reactant production by a reactant processor of a fuel cell system; and
during a time period in which the fuel cell system is continuously operating, adapting the model based on feedback received from the fuel cell system and controlling the fuel cell system using an indication of the reactant production from the model.

2. The method of claim 1, wherein the act of providing the mathematical model comprises:
providing a mathematical model of hydrogen production by a reformer of the fuel cell system.

3. The method of claim 1, further comprising:
adapting the model during at least one of startup, shutdown, or normal operating phases of the fuel cell system.

4. The method of claim 1, wherein the act of adapting the model comprises:
determining a first setting for an attribute of a component of the fuel cell system;
based on the feedback, determining a second setting for the attribute; and
comparing the first and second settings to generate a correction for the model.

5. The method of claim 4, wherein the component comprises a motor and the attribute comprises a speed of the motor.

6. The method of claim 4, wherein the component comprises a cathode blower and the attribute comprises a speed of the blower.

7. The method of claim 1, wherein the act of providing comprises:
providing a model of reactant production by the reactant processor as a function of an input flow to the reactant processor.

8. The method of claim 1, wherein the act of providing comprises:
providing a model of hydrogen production by a reformer as a function of a hydrocarbon flow into the reformer.

9. A fuel cell system, comprising:
a reactant processor to provide a reactant flow for a fuel cell of the fuel cell system; and
a controller to:
use a mathematical model to generate an indication of reactant production by the reactant processor, and
during a time period in which the fuel cell system is continuously operating, adapt the model based on feedback received from the fuel cell system and control the fuel cell system using an indication of the reactant production from the model.

10. The fuel cell system of claim 9, wherein the reactant processor comprises a reformer and the mathematical model comprises a model of hydrogen production by the reformer.

11. The fuel cell system of claim 9, wherein the controller adapts the model during at least one of startup, shutdown or normal operating phases of the fuel cell system.

12. The fuel cell system of claim 9, further comprising:
a component having an attribute regulated by the controller, wherein
the controller is adapted to:
determine a first setting for the attribute;
based on the feedback, determine a second setting for the attribute; and
compare the first and second settings to generate a correction for the model.

13. The fuel cell system of claim 12, wherein the component comprises a motor and the attribute comprises a speed of the motor.

14. The fuel cell system of claim 12, wherein the component comprises a cathode blower and the attribute comprises a speed of the blower.

15. The fuel cell system of claim 9, wherein the model indicates the reactant production by the reactant processor as a function of an input flow to the reactant processor.

16. The fuel cell system of claim 9, wherein the reactant processor comprises a reformer and the model indicates hydrogen production by the reformer as a function of a hydrocarbon flow into the reformer.

17. An article comprising a computer readable storage medium accessible by a processor-based system to store instructions that when executed by the processor-based system cause the processor-based system to:
provide a mathematical model of reactant production by a reactant processor of a fuel cell system; and
during a time period in which the fuel cell system is continuously operating, adapt the model based on feedback received from the fuel cell system and control the fuel cell system using an indication of the reactant production from the model.

18. The article of claim 17, the storage medium storing instructions that when executed cause the processor-based system to:
determine a first setting for an attribute of a component of the fuel cell system;
based on the feedback, determine a second setting for the attribute; and
compare the first and second settings to generate a correction for the model.

19. The article of claim 18, wherein the component comprises a cathode air blower and the attribute comprises a speed of the blower.

20. The article of claim 17, wherein
the reactant processor comprises a reformer, and
the reactant production comprises a hydrogen production by the reformer.
